(19) United States
(12) Patent Application Publication
(10) Pub. No.: US 2008/0247940 A1
(43) Pub. Date: Oct. 9, 2008

(54) Carbon Black Coloring Agent for Semiconductor Sealing Material and Method of Manufacturing the Same

(76) Inventor: Shigemi Toda, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 11/632,565

(22) PCT Filed: Aug. 10, 2005
(86) PCT No.: PCT/JP05/14972

§ 371 Date: Jan. 24, 2008

(30) Foreign Application Priority Data
Aug. 11, 2004 (JP) 2004-234013

(51) Int. Cl. C01B 31/02

(52) U.S. Cl. 423/449.1

(57) ABSTRACT

The present invention provides a carbon black coloring agent suitable as a black coloring agent for a semiconductor sealing material, exhibiting excellent dispersibility in a resin component, and capable of forming a semiconductor sealing material having a high volume resistivity and excellent shading properties, and a method of manufacturing the same. The carbon black coloring agent has a structure in which terminal hydrogen of a carboxyl group formed on the surface of a carbon black particle by wet oxidation using sodium persulfate or ammonium persulfate is replaced by ammonia, and has a pH of 3.0 to 8.0. The method includes subjecting carbon black to wet oxidation in a sodium persulfate aqueous solution or an ammonium persulfate aqueous solution, removing reducing salts by deionization, adding an ammonia aqueous solution reaction to adjust the pH of the slurry to 4.0 to 12.0, causing the carbon black to react with ammonia, purifying the slurry by removing foreign matter from the slurry, and drying and grinding the carbon black. It is preferable to subject the carbon black to dry oxidation in advance before wet oxidation and to add a surfactant when subjecting the carbon black to wet oxidation.

### TECHNICAL FIELD

The present invention relates to a carbon black coloring agent suitable as a black coloring agent for a semiconductor sealing material resin composition, and a method of manufacturing the same.

### BACKGROUND ART

An increase in performance and function of electronic instruments has been increasingly demanded with the arrival of the multimedia era. To deal with this demand, an IC package used for electronic instruments has been reduced in size and thickness and provided with an increased number of pins. A semiconductor chip is formed by sealing the entire IC chip with a sealing material in order to protect minute and complicated electronic circuits formed on the surface of the IC chip from dust or moisture in the air or from external force.

An epoxy resin sealing material is most widely used at present as a sealing material for a semiconductor IC chip. The epoxy resin sealing material is roughly divided into a transfer-molding epoxy resin sealing material and a liquid epoxy resin sealing material. Since the liquid epoxy resin sealing material is limited in its application, the transfer-molding epoxy resin sealing material has been mainly used.

In recent years, the liquid epoxy resin sealing material has become used particularly as a sealing material for a state-of-the-art semiconductor device, such as a plastic pin grid array (P-PGA), a flip-chip, or a chip size package or a chip scale package (CSP). Along with a demand for a further reduction in size and thickness of semiconductor devices, a demand for a potting molding method using the liquid epoxy resin sealing material is expected to be increased.

A semiconductor resin sealing material generally contains a resin, a curing agent, a curing accelerator, an inorganic filler, and the like. JP-A-8-81544 discloses a liquid resin sealing material containing, as essential components, (A) an epoxy resin, (B) a curing catalyst consisting of (a) an aluminum compound containing an organic group and (b) a silicone compound or an organosilane compound containing at least one OH group or hydrolyzable group directly bonded to Si in the molecule, and (C) silica powder, for example.

A semiconductor resin sealing material is usually colored black in order to prevent an electrical failure caused by a photo-induced current generated when light is applied to the semiconductor chip. As the black coloring agent, carbon black which exhibits excellent shading properties and conductivity (for electrostatic prevention) has been widely used. As a semiconductor sealing resin composition which provides a uniform degree of blackness, JP-A-2000-7894 discloses a semiconductor sealing resin composition containing an epoxy resin, a phenol resin curing agent, a curing accelerator, an inorganic filler, and carbon black as essential components, the carbon black having an average particle diameter of 10 to 100 nm, a specific surface area determined by a BET method of 50 to 500 m²/g, and a pH of 6.5 to 8.5, the composition containing the carbon black in an amount of 0.05 to 1.0 wt % of the total amount of the composition, for example.

When using carbon black as the black coloring agent, it is important that the carbon black exhibit excellent dispersibility in the resin and be minutely dispersed in the resin without aggregating during curing of the resin. However, the carbon black is in the form of very minute particles and exists as an aggregate or agglomerate in which the minute particles are three-dimensionally bonded due to high aggregating properties. For example, when using this type of carbon black, the carbon black tends to aggregate during curing of the resin composition.

As a black composite particle powder for a semiconductor sealing material exhibiting a high degree of blackness, moisture resistance, flowability, and coloring properties and having excellent dispersibility in a binder resin, JP-A-2003-226823 discloses a black composite particle powder for a liquid semiconductor sealing material containing a black composite particle powder having an average particle diameter of 1.0 to 30.0 μm, in which the surfaces of extender particles are coated with an adhesive and carbon black adheres to the coating, the amount of the carbon black adhering to the coating being 1 to 100 parts by weights for 100 parts by weight of the extender.

### DISCLOSURE OF THE INVENTION

However, since the black composite particle powder disclosed in JP-A-2003-226823 is produced by coating the surfaces of the extender particles such as fine silica particles with the adhesive and causing the carbon black to adhere to the adhesive coating, the carbon black may be removed from the adhesive when mixing the black composite particle powder with a resin and a curing agent in order to obtain a semiconductor sealing material, or the use temperature may be limited depending on the adhesive. Moreover, furnace black, channel black, acetylene black, or the like is directly used as the carbon black for the adhesion treatment, and modification of the carbon black is not taken into consideration.

The inventor of the present invention conducted extensive studies on the surface properties and on surface modification of carbon black. As a result, the inventor has found that, when carbon black is subjected to wet oxidation using sodium persulfate or ammonium persulfate, and terminal hydrogen of a carboxyl group on the surface of the carbon black particle formed by wet oxidation is replaced by ammonia, the carbon black exhibits improved dispersibility in a resin component, does not aggregate during curing of the resin, and forms a semiconductor sealing material having excellent shading properties and a high volume resistivity.

The present invention has been completed based on this finding. Specifically, an object of the present invention is to provide a carbon black coloring agent suitable as a black coloring agent for a semiconductor sealing material, exhibiting excellent dispersibility in a resin component, and capable of forming a semiconductor sealing material having a high volume resistivity and excellent shading properties, and a method of manufacturing the same.

In order to achieve the above object, a carbon black coloring agent for a semiconductor sealing material according to claim 1 has a structure in which terminal hydrogen of a carboxyl group formed on a surface of a carbon black particle by wet oxidation using sodium persulfate or ammonium persulfate is replaced by ammonia, and has a pH of 3.0 to 8.0.

A method of manufacturing a carbon black coloring agent for a semiconductor sealing material according to claim 2 comprises subjecting carbon black to wet oxidation in a sodium persulfate aqueous solution or an ammonium persulfate aqueous solution, removing reducing salts by deionization, adding an ammonia aqueous solution to adjust the pH of the slurry to 4.0 to 12.0, causing the carbon black to react with ammonia, purifying the slurry by removing foreign matter from the slurry, and drying and grinding the carbon black.

In the method according to claim 2, the carbon black subjected to dry oxidation in advance may be subjected to wet oxidation.

In the method according to claim 2, a surfactant may be added when subjecting the carbon black to wet oxidation.

According to the present invention, a carbon black coloring agent suitable as a black coloring agent for a resin composition, exhibiting excellent dispersibility in the resin component, aggregating to only a small extent during curing of the resin composition, and capable of forming a semiconductor sealing material having a high volume resistivity and excellent shading properties, and a method of manufacturing the same can be provided.

### BEST MODE FOR CARRYING OUT THE INVENTION

The carbon black used in the present invention is not particularly limited. Various commercially available products such as furnace black, thermal black, channel black, and acetylene black may be used.

In the carbon black coloring agent for a semiconductor sealing material of the present invention, terminal hydrogen of a carboxyl group among functional groups on the surface of the carbon black particle formed by wet oxidation of the carbon black using sodium persulfate or ammonium persulfate is replaced by ammonia.

Specifically, the carbon black coloring agent of the present invention exhibits excellent dispersibility in an epoxy resin and does not reaggregate during curing of the epoxy resin by replacing terminal hydrogen of a carboxyl group formed on the surface of the carbon black particle by ammonia, and adjusting the pH of the carbon black to 3.0 to 8.0. A semiconductor sealing material formed by using an epoxy resin composition in which the carbon black coloring agent is dispersed exhibits excellent performance such as excellent shading properties and a high volume resistivity.

The pH of the carbon black is the value measured according to JIS K 5101 (1991) “Test methods for pigments”.

The carbon black coloring agent for a semiconductor sealing material is manufactured by subjecting the carbon black to wet oxidation by stirring and mixing the carbon black in a sodium persulfate aqueous solution or an ammonium persulfate aqueous solution, removing reducing salts by deionization, adding an ammonia aqueous solution reaction to the mixture, causing the carbon black to react with ammonia, purifying the slurry by removing foreign matter from the slurry, and drying and grinding the carbon black.

As the carbon black oxidation method, a wet method and a dry method may be used. It is preferable to use the wet method from the viewpoint of uniformly oxidizing the surface of the carbon black particle. As the wet medium used for wet oxidation, water, alcohol, volatile oil, or the like may be used. It is preferable to use inexpensive and safe water. The following description is given taking the case of using water as the wet medium as an example.

The wet oxidation of the carbon black is performed in order to modify the carbon black, which originally has hydrophobic surface properties, to have hydrophilic surface properties. The wet oxidation is performed by dispersing the carbon black in a sodium persulfate aqueous solution or an ammonium persulfate aqueous solution as an oxidizing agent, and stirring the mixture at an appropriate oxidizing agent concentration, time, temperature, and the like. This treatment causes hydrophilic functional groups, such as a hydroxyl group and a carboxyl group, to be formed on the surface of the carbon black particle.

It is preferable to use carbon black subjected in advance to dry oxidization by heating the carbon black at an appropriate temperature using a gaseous oxidizing agent such as air, oxygen, ozone, NOₓ, or SOₓ, since wet oxidation proceeds more effectively.

The carbon black can undergo wet oxidation more effectively by improving the dispersibility in water by adding a surfactant to the sodium persulfate aqueous solution or ammonium persulfate aqueous solution when subjecting the carbon black to wet oxidation. As the surfactant, an anionic surfactant, nonionic surfactant, or cationic surfactant may be used.

As examples of the anionic surfactant, a fatty acid salt, alkyl sulfate, alkylaryl sulfonate, alkyl naphthalenesulfonate, dialkyl sulfonate, dialkyl sulfosuccinate, alkyl diaryl ether disulfonate, alkyl phosphate, polyoxyethylene alkyl ether sulfate, polyoxyethylene alkyl aryl ether sulfate, naphthalenesulfonic acid-formalin condensate, polyoxyethylene alkyl phosphate, glycerol borate fatty acid ester, polyoxyethylene glycerol fatty acid ester, and the like can be given. In the semiconductor application, an ammonium salt is preferably used as the salt.

As examples of the nonionic surfactant, a polyoxyethylene alkyl ether, polyoxyethylene alkyl aryl ether, polyoxyethylene-oxypropylene block copolymer, sorbitan fatty acid ester, polyoxyethylene sorbitan fatty acid ester, glyceride fatty acid ester, polyoxyethylene alkylamine, nonionic fluorine or silicone surfactant, and the like can be given.

As examples of the cationic surfactant, alkylamine salt, quaternary ammonium salt, polyoxyethylenealkylamine, and the like can be given.

In the carbon black slurry prepared by subjecting the carbon black to wet oxidation in the sodium persulfate aqueous solution or ammonium persulfate aqueous solution, since the carbon black aggregates in the slurry due to a decrease in water dispersibility if reducing salts in the slurry produced by the oxidation reaction are not removed, the reducing salts are removed by deionization by using a separation membrane such as an ultrafilter membrane (UF), reverse osmosis membrane (RO membrane), or an electrodialysis membrane. The deionization is preferably performed until the electric conductivity becomes 200 μS/cm or less when the carbon black concentration in the slurry is 3 wt %, for example.

An ammonia aqueous solution is then added to the carbon black slurry and the mixture is heated and stirred to replace terminal hydrogen of a carboxyl group on the surface of the carbon black particle formed by wet oxidation by ammonia. The pH of the resulting carbon black coloring agent can be adjusted to 3.0 to 8.0 by adjusting the pH of the carbon black slurry during this reaction to 4.0 to 12.0. If the pH of the resulting carbon black coloring agent is less than 3:0, since the terminal hydrogen of the carboxyl group on the surface of the carbon black particle is replaced by ammonia to only a small extent, the carbon black coloring agent may aggregate during curing of a resin composition when preparing a resin composition using the carbon black coloring agent. On the other hand, if the pH of the resulting carbon black coloring agent exceeds 8.0, the storage stability of the resin composition may be decreased.

There may be a case where foreign matter such as undispersed carbon black particles or carbon black aggregate or grit remain in the slurry after the reaction. Such foreign matter must be removed since the volume resistivity of the resulting semiconductor sealing material is decreased. The foreign matter may be removed by performing centrifugal classification and separating the foreign matter using a filter with a pore size of 5 μm or less, for example.

The slurry purified by removing the foreign matter is dried by removing water by evaporation. The resulting carbon black is ground by using a grinding machine such as a jet mill, cutter mixer, or ball mill to obtain a carbon black coloring agent for a semiconductor sealing material of the present invention.

The carbon black coloring agent for a semiconductor sealing material of the present invention thus obtained is mixed with an epoxy resin, curing agent, curing accelerator, inorganic filler, and the like generally used for sealing electronic parts to obtain a semiconductor sealing material resin composition.

The molecular structure and the molecular weight of the epoxy resin used are not particularly limited insofar as the epoxy resin contains two or more epoxy groups in one molecule. It is preferable to use an epoxy resin which is liquid at room temperature. As examples of the epoxy resin, a bisphenol-type epoxy resin such as a bisphenol A-type epoxy resin and a bisphenol F-type epoxy resin, a novolak-type epoxy resin such as a phenol novolak-type epoxy resin and a cresol novolak-type epoxy resin, a triphenylalkane-type epoxy resin such as a triphenolmethane-type epoxy resin and a triphenolpropane-type epoxy resin, a phenolaralkyl-type epoxy resin, a biphenylaralkyl-type epoxy resin, a stilbene-type epoxy resin, a naphthalene-type epoxy resin, a biphenyl-type epoxy resin, a cyclopentadiene-type epoxy resin, and the like can be given. The epoxy resin may be used either individually or in combination of two or more. A solid epoxy resin such as a bisphenol-type epoxy resin may be mixed, as required, from the viewpoint of increasing the mechanical strength of the resulting liquid semiconductor sealing material and the like.

It is preferable that the total chlorine content of the epoxy resin be 1500 ppm or less, and preferably 1000 ppm or less. It is preferable that the chlorine content in water after extraction at 100° C. for 20 hours at an epoxy resin concentration of 50% be 10 ppm or less. If the total chlorine content exceeds 1500 ppm and the chlorine content in water exceeds 10 ppm, the reliability, particularly the moisture resistance, of an semiconductor element may be adversely affected.

The molecular structure and the molecular weight of the curing agent for the epoxy resin are not particularly limited insofar as the curing agent is a compound containing two or more functional groups (e.g. phenolic hydroxyl group, amino group, or acid anhydride group) which can react with the epoxy group of the epoxy resin. A known compound may be used as the curing agent. For example, a phenol resin containing at least two phenolic hydroxyl groups in one molecule, for instance, a novolak-type phenolic resin such as a phenol novolac resin or a cresol novolac resin, a xylylene-modified novolac resin such as a paraxylylene-modified novolac resin, a metaxylylene-modified novolac resin, or an orthoxylylene-modified novolac resin, a bisphenol-type phenol resin such as a bisphenol A-type resin or a bisphenol F-type resin, a biphenyl-type phenol resin, a resole-type phenol resin, a phenol aralkyl-type resin, a biphenylaralkyl-type resin, a triphenylalkane-type resin such as a triphenylmethane-type resin or a triphenylpropane-type resin, a naphthalene ring-containing phenol resin, or a dicyclopentadiene-modified phenol resin may be used. An acid anhydride curing agent such as phthalic anhydride, maleic anhydride, or tetrahydrophthalic anhydride, an amine-type curing agent such as an aliphatic polyamine, a polyamide resin, or an aromatic diamine, a Lewis acid complex compound, or the like may also be used. In addition, a carboxylic acid hydrazide such as dicyandiamide, adipic acid hydrazide, or isophthalic acid hydrazide may also be used.

As the curing accelerator which accelerates the reaction between the epoxy resin and the curing agent, 1,8-diazabicyclo(5,4,0)undecene-7, triphenylphosphine, benzyldimethylamine, 2-methylimidazole, or the like may be used.

As the inorganic filler, a known inorganic filler used to reduce the coefficient of expansion may be used. For example, fused silica, crystalline silica, alumina, boron nitride, aluminum nitride, silicon nitride, magnesia, magnesium silicate, or the like may be used. It is preferable to use spherical fused silica from the viewpoint of reducing the viscosity and ensuring high filling properties.

In the present invention, additives such as a stress reduction agent such as silicone rubber, a coupling agent, a surface treatment agent, a flame retardant, and a flame retardant assistant may optionally be added in combination with the essential components.

A semiconductor sealing material resin composition is prepared by stirring, dissolving, mixing, and dispersing the carbon black coloring agent for a semiconductor sealing material of the present invention with the above epoxy resin, curing agent, curing accelerator, inorganic filler, and the like at a specific ratio by using a grinder, triple-roll mill, ball mill, planetary mixer, or the like. It is preferable that the viscosity of the resin composition be 10,000 poise or less at 25° C.

### EXAMPLES

Examples of the present invention are described below. However, the present invention is not limited to the following examples.

### Example 1

Carbon black having a nitrogen adsorption specific surface area (N₂SA) of 135 m²/g and a DBP absorption of 56 cm³/100 g (“Tokablack #7550F” manufactured by Tokai Carbon Co., Ltd.) was used. The amount of sodium peroxodisulfate was calculated from the equation given below so that 0.20 mmol/m² of sodium peroxodisulfate ((Na)₂S₂O₈) reacts per unit surface area of the carbon black. 100 g of the carbon black was added to a sodium peroxodisulfate aqueous solution (3 dm³) prepared by dissolving sodium peroxodisulfate in the calculated amount in pure water, and the mixture was stirred and mixed at a temperature of 60° C. for 10 hours at a stirring speed of 0.12 s⁻¹ to effect wet oxidation.

### Calculation of Amount of Sodium Peroxodisulfate:

Amount of sodium peroxodisulfate=(sodium peroxodisulfate (mmol/m²) necessary per unit surface area of carbon black)×(nitrogen adsorption specific surface area (m²/g) of carbon black)×(equivalent of sodium peroxodisulfate (238.1 g/mol))

In this case, the weight of sodium peroxodisulfate required is “0.20 (mmol/m²)×135 (m²/g)×100 (g)×238.1 (g/mol)=642.87 (g)” for 100 g of carbon black.

Reducing salts were removed from the carbon black slurry after wet oxidation by deionization using an ultrafilter membrane (“AHP-1010” manufactured by Asahi Kasei Corporation; molecular weight cut-off: 50,000) until the electric conductivity became 200 μS/cm or less. After adjusting the pH of the carbon black slurry to 8.5 by adding 0.15 dm³ of aqueous ammonia at a concentration of 0.5N to the carbon black slurry after deionization, the mixture was allowed to react at a temperature of 98° C. for three hours at a stirring speed of 0.15 s⁻¹.

The carbon black slurry after the reaction was subjected to classification by using a centrifuge (“CR22F” manufactured by Hitachi Koki Co., Ltd.) for 10 minutes at a rotational speed of 10⁻² s⁻¹ to remove large particles. The supernatant liquid was filtered through a filter with a pore size of 1 μm, and the carbon black slurry which had passed through the filter was dried at 110° C. in a dryer. After drying, the carbon black aggregate was crushed by using a cutter mixer, and ground by using a single track jet mill (“STJ-200” manufactured by Seishin Enterprise Co., Ltd.) to obtain a carbon black coloring agent.

### Example 2

A carbon black coloring agent was prepared in the same manner as in Example 1 except that the carbon black was placed in an ozonizer (“10T-4A6” manufactured by Nippon Ozone Co., Ltd.) and subjected to dry oxidation for five hours at a generation voltage of 200 V and an ozone generation amount of 5 mg/s before subjecting the carbon black to wet oxidation using the sodium peroxodisulfate aqueous solution.

### Example 3

A carbon black coloring agent was prepared in the same manner as in Example 1 except that a nonionic surfactant (“Emulgen A500” manufactured by the Kao Corporation) was added before wet oxidation in an amount of 10 wt % with respect to the carbon black.

### Comparative Example 1

The carbon black used in Example 1 was used as a carbon black coloring agent.

### Comparative Example 2

A carbon black coloring agent was prepared in the same manner as in Example 1 except that the carbon black slurry, which was subjected to wet oxidation and from which the reducing salts were removed by deionization, was directly centrifuged and filtered without adding aqueous ammonia.

### Comparative Example 3

A carbon black coloring agent was prepared in the same manner as in Example 1 except that the amount of aqueous ammonia added was increased to 1.50 dm³ to adjust the pH to 12.5.

The carbon black coloring agents thus obtained are summarized in Table I together with the manufacturing conditions.

TABLE 1

| | | | | | Comparative | Comparative | Comparative |
|---|---|---|---|---|---|---|---|
| | | Example 1 | Example 2 | Example 3 | Example 1 | Example 2 | Example 3 |
| Oxidation | Dry*¹ | None | Done | None | None | None | None |
| | Wet*² | Done | Done | Done | None | Done | Done |

| | | | | | | |
|---|---|---|---|---|---|---|
| Surfactant | None | None | Added | None | None | None |
| Aqueous ammonia | Added | Added | Added | None | None | Added |
| pH of CB coloring agent | 6.8 | 6.8 | 6.8 | 7.2 | 2.7 | 9.6 |

*¹Gas phase oxidation using ozone
*²Liquid phase oxidation using sodium peroxodisulfate aqueous solution

The carbon black coloring agent was mixed with the following raw materials by using a triple-roll mill to prepare a semiconductor sealing resin composition.
Bisphenol A-type epoxy resin (“RE410” manufactured by Nippon Kayaku Co., Ltd.): 20%
Methyltetrahydrophthalic anhydride (“MH700” manufactured by New Japan Chemical Co., Ltd.): 18%
Dimethylaminomethylphenol: 0.2%
Spherical silica (“SE8FC” manufactured by Tokuyama Soda Co., Ltd., maximum particle diameter: 24 μm or less, average particle diameter: 8 μm): 59.2%
γ-Glycidoxypropyltrimethoxysilane (“KBM403” manufactured by Shin-Etsu Chemical Co., Ltd.): 0.7%
Carbon black coloring agent: 0.1%

The viscosity, storage stability, and the like of the resin composition were measured according to the following methods. The results are shown in Table 2.

### Viscosity:

The viscosity of the resin composition was measured by using an E-type viscometer (“TVE-30H” manufactured by Tokimec Inc.) with a 3° R14 cone rotor at a temperature of 25° C. and a rotor speed of 2.5 rpm.

### Storage Stability:

The viscosity of the resin composition immediately after production (initial viscosity) and the viscosity of the resin composition 30 days after production were measured, and an increase rate (%) of the viscosity 30 days after production to the initial viscosity was determined. The larger the value, the poorer the storage stability.

A TBA semiconductor section was sealed by using the resin composition, and the resin composition was cured by heating at 100° C. for one hour and at 150° C. for one hour to obtain a semiconductor sealing material. The properties of the semiconductor sealing material were determined according to the following methods.

### Dispersibility:

The cross section of the semiconductor sealing material was photographed by using an optical microscope. The number of undispersed aggregate particles present in the micrograph (×200) was counted to evaluate the dispersibility according to the following five stages. The stage “5” indicates the most excellent dispersion state.
1: The number of undispersed aggregate particles is 50 or more in 0.25 mm².
2: The number of undispersed aggregate particles is 10 or more and less than 50 in 0.25 mm².
3: The number of undispersed aggregate particles is 5 or more and less than 10 in 0.25 mm².
4: The number of undispersed aggregate particles is 1 or more and less than 5 in 0.25 mm².
5: No undispersed aggregate particles are observed in 0.25 mm².

### Volume Resistivity:

The semiconductor sealing material was punched to prepare a columnar measurement specimen. The measurement specimen was allowed to stand at a temperature of 25° C. and a relative humidity of 60% for 12 hours or more, and placed between stainless steel electrodes. The resistance R (Ω) of the measurement specimen was measured by applying a voltage of 15 V using a Wheatstone bridge (“Type 2768” manufactured by Yokogawa Hokushin Electric Corporation). The area A (cm²) and the thickness t (cm) of the top surface of the measurement specimen were measured, and the volume resistivity (Ω·cm) was calculated from the following equation.

Volume resistivity (Ω·cm)=R×(A/t)

### Shading Properties:

The semiconductor sealing material was processed into a plate with dimensions of 50×50×0.5 mm to prepare a measurement specimen. The reflection optical density (OD) was measured at five points on the surface of the specimen by using a Macbeth densitometer (“RD-927” manufactured by Kollmorgen).

TABLE 2

| | | | | Comparative | Comparative | Comparative |
|---|---|---|---|---|---|---|
| | Example 1 | Example 2 | Example 3 | Example 1 | Example 2 | Example 3 |
| Viscosity (Pa · s/25° C.) | 22.1 | 21.9 | 22.0 | 32.1 | 32.3 | 32.0 |
| Storage stability (%) | 113 | 115 | 114 | 145 | 141 | 142 |
| Dispersibility | 5 | 4 | 4 | 1 | 2 | 2 |
| Volume resistibility (Ω · cm) | 3.5 × 10¹⁰ | 2.9 × 10¹⁰ | 2.9 × 10¹⁰ | 3.0 × 10⁸ | 2.8 × 10⁸ | 3.0 × 10⁵ |
| Shading properties (OD) | 2.0 | 1.9 | 1.9 | 0.9 | 1.4 | 1.5 |

As is clear from the comparison between the examples and the comparative examples, the carbon black coloring agent of the present invention manufactured by the manufacturing method of the present invention exhibits excellent dispersibility in the resin component. The resin composition prepared by using the carbon black coloring agent of the present invention exhibits a high volume resistivity and excellent shading properties. Therefore, the carbon black coloring agent of the present invention is suitable as a black coloring agent for a semiconductor sealing material resin composition.

1. A carbon black coloring agent for a semiconductor sealing material, the carbon black coloring agent having a structure in which terminal hydrogen of a carboxyl group formed on a surface of a carbon black particle by wet oxidation using sodium persulfate or ammonium persulfate is replaced by ammonia, and having a pH of 3.0 to 8.0.

2. A method of manufacturing a carbon black coloring agent for a semiconductor sealing material, the method comprising: subjecting carbon black to wet oxidation in a sodium persulfate aqueous solution or an ammonium persulfate aqueous solution, removing reducing salts by deionization, adding an ammonia aqueous solution to adjust the pH of the slurry to 4.0 to 12.0, causing the carbon black to react with ammonia, purifying the slurry by removing foreign matter from the slurry, and drying and grinding the carbon black.

3. The method according to claim 2, wherein the carbon black subjected to dry oxidation in advance is subjected to wet oxidation.

4. The method according to claim 2, wherein a surfactant is added when subjecting the carbon black to wet oxidation.
